(19) United States
(12) Patent Application Publication
(10) Pub. No.: US 2019/0139654 A1
(43) Pub. Date: May 9, 2019

(54) HIGH TEMPERATURE NUCLEAR FUEL SYSTEM FOR THERMAL NEUTRON REACTORS

(71) Applicant: WESTINGHOUSE ELECTRIC COMPANY, LLC, Cranberry Township, PA (US)

(72) Inventors: EDWARD J. LAHODA, EDGEWOOD, PA (US); PENG XU, COLUMBIA, SC (US); Robert L. Oelrich, JR., Columbia, SC (US); FRANK A. BOYLAN, ELLWOOD CITY, PA (US); HEMANT SHAH, COLUMBIA, SC (US); SUMIT RAY, COLUMBIA, SC (US); FAUSTO FRANCESCHINI, PITTSBURGH, PA (US); JAVIER E. ROMERO, COLUMBIA, SC (US); JONATHAN WRIGHT, VASTERAS (SE)

(73) Assignee: WESTINGHOUSE ELECTRIC COMPANY, LLC, Cranberry Township, PA (US)

(21) Appl. No.: 16/174,767

(22) Filed: Oct. 30, 2018

Related U.S. Application Data
(60) Provisional application No. 62/579,340, filed on Oct. 31, 2017.

(51) Int. Cl. G21C 3/07; G21C 1/04; G21C 3/62; G21C 7/04; G21C 3/04

(52) U.S. Cl. CPC G21C 3/07; G21C 1/04; G21C 3/047; G21C 7/04; G21C 3/626

(57) ABSTRACT

An improved, accident tolerant fuel for use in light water and heavy water reactors is described. The fuel includes a zirconium alloy cladding having a chromium or chromium alloy coating and an optional interlayer of molybdenum, tantalum, tungsten, and niobium between the zirconium alloy cladding and the coating, and fuel pellets formed from U₃Si₂ or UN and from 100 to 10000 ppm of a boron-containing integral fuel burnable absorber, such as UB₂ or ZrB₂, either intermixed within the fuel pellet or coated over the surface of the fuel pellet.

### STATEMENT REGARDING GOVERNMENT RIGHTS

This invention was made with government support under Contract No. DE-NE0008222 awarded by the Department of Energy. The U.S. Government has certain rights in this invention.

### BACKGROUND OF THE INVENTION

### 1. Field of the Invention

The invention relates to nuclear fuel, and more specifically to an accident tolerant fuel for use in light and heavy water reactors.

### 2. Description of the Prior Art

Fissile material for use as nuclear fuel includes uranium dioxide (UO₂), plutonium dioxide (PuO₂), uranium nitride (UN) either with natural nitrogen or nitrogen enriched in the ¹⁵N isotope, and/or tri-uranium disilicide (U₃Si₂), typically in pellet form. Fuel rods are encased in a cladding that acts as a containment for the fissile material. The cladding is preferably in the form of an elongate structure, such as a tube, and the fuel rod includes a plurality of pellets stacked in the cladding tube. In a typical fuel rod, the top and bottom ends of the rod are closed with end caps and a spring or other device to bias the fuel pellets together in the stack is positioned within the cladding on one end of the fuel rod. In a reactor, fuel rods are grouped together in an array which is organized to provide a neutron flux in the core sufficient to support a high rate of nuclear fission and the release of a large amount of energy in the form of heat.

UO₂ is currently a widely used nuclear fuel. Although susceptible to water and steam oxidation, U₃Si₂ is the favored fuel material for accident tolerant fuel (ATF) systems. U₃Si₂ has a high density (12.2 gm/cm³), very high thermal conductivity (up to 5×UO₂), and a melting point of 1665° C. To date, however, its use has been confined to lead test rods in test reactors where it is buried in a thick aluminum cladding which makes water coolant exposure unlikely, and where integral fuel burnable absorbers (IFBA) are not a required component of the fuel.

To be accident tolerant, nuclear fuel components are designed for accidents that can result in fuel temperatures of about 1700° C. assuming the addition of a minimal amount of a coolant in the fuel assembly. Nuclear fuels have been combined with a coated zirconium alloy cladding. Due to the ability of the coated zirconium to expand with the expanding pellet during the useful life of the fissile material, the gap between the pellet and the cladding, which is a major source of thermal heat transfer resistance, can be small, keeping the centerline temperature below the melting point under all transient conditions. The relatively low melting point of U₃Si₂ is therefore not an issue because the very high thermal conductivity of U₃Si₂ precludes fuel centerline melt issues during unexpected power transients.

Under severe conditions such as “beyond design basis” accidents; metal cladding can react exothermally with steam at over 1093° C. Zirconium cladding metals protecting the nuclear fuel may lose strength during “a loss of coolant” accident, where reactor temperatures can reach as high as 1204° C., and expand due to internal fission gases within the fuel rod.

The melting point of a mixture of two or more solids (such as an alloy) depends on the relative proportions of the ingredients. A low melting eutectic mixture forms when the solids are at such proportions that the melting point of the mixture is as low as possible. In the case of alloys used in situations where relatively low melting points can create unintended problems, the formation of eutectic mixtures is ideally avoided or the undesirable consequences of a eutectic mixture formation is ideally minimized.

Suggestions for protecting and strengthening Zr claddings include coating the Zr alloy, but formation of a eutectic mixture can present a problem for coated Zr alloy claddings. While a Zr alloy cladding coated, for example, with Cr initially provides up to 300° C. more temperature tolerance than does a Zr cladding alone, this increased tolerance comes at the expense of reduced cladding strength due to the formation of a liquid eutectic layer formed between the Cr coating and the Zr alloy cladding, thus lowering the melting temperature of the coated cladding, leaving the fuel susceptible to loss of coolant accidents.

If U₃Si₂ is to be used in commercial nuclear power generation, considerations not required for smaller scale test uses must be addressed.

### SUMMARY OF THE INVENTION

The following summary is provided to facilitate an understanding of some of the innovative features unique to the embodiments disclosed and is not intended to be a full description. A full appreciation of the various aspects of the embodiments can be gained by taking the entire specification, claims, and abstract as a whole.

An improved accident tolerant fuel rod for use in light and heavy water reactors is described herein. The fuel rod includes in various aspects, a nuclear fuel selected from the group consisting of U₃Si₂ and UN, in pellet form, a boron-containing integral fuel burnable absorber, and a zirconium-containing cladding material for housing the nuclear fuel and the integral fuel burnable absorber. The cladding material may have a coating applied thereto. The coating may be selected from the group consisting of Cr or a Cr alloy. The Cr alloy may be FeCrAl and FeCrAlY.

In certain aspects of the fuel rod, an interlayer is disposed between the cladding material and the coating. The interlayer may have a thickness of 1 to 20 microns. The interlayer may be selected from the group consisting of a Mo, Ta, W, and Nb.

The interlayer may be applied to the exterior surface of the cladding material by a hot spray process, such as a plasma arc process, or by a cold spray process.

In various aspects, the coating may have a thickness of 5 to 50 microns, and may be applied to the cladding material, or to the interlayer in those embodiments where an interlayer is included, by a cold spray process.

The integral fuel burnable absorber may be selected from the group consisting of UB₂ and ZrB₂, and in certain aspects, may be intermixed with the nuclear fuel in the pellet. The burnable absorber content intermixed in the fuel pellet may be between 100 ppm and 10000 ppm. When the integral burnable absorber is UB₂, it may have UBx components of between 0% and up to 100%, where x is a whole number or fraction thereof from 0 to 12, or more. That is, most of the absorber may be in a phase other than UB₂. In certain other aspects, the burnable absorber may be coated on the exterior surface of the fuel pellet.

### BRIEF DESCRIPTION OF THE DRAWINGS

The characteristics and advantages of the present disclosure may be better understood by reference to the accompanying figures.

FIG. 1A is a side section view of an exemplary fuel rod showing a stack of coated fuel pellets housed in a coated cladding.

FIG. 1B is a cross-section of the fuel rod and fuel pellet through the line 1B-1B of FIG. 1A.

FIG. 2A is a side section view of an exemplary fuel rod showing an uncoated stack of fuel pellets housed in a cladding having an interlayer disposed between the cladding and the coating.

FIG. 2B is a cross-section of the fuel rod and fuel pellet through the line 2B-2B of FIG. 2A.

FIG. 3 is a phase diagram showing the eutectic temperature range for relative atomic % concentrations of Niobium (Nb) and Zirconium (Zr) combinations. The phase diagram plots relative concentrations of Nb and Zr along the horizontal axis, and temperature along the vertical axis. The eutectic point is the point at which the liquid phase (L) borders directly on the solid phase (composed of both Nb and Zr), representing the minimum melting temperature of any possible alloy of Nb and Zr.

FIG. 4 is a phase diagram showing the eutectic temperature range for relative atomic % concentrations of Niobium (Nb) and Chromium (Cr) combinations.

### DESCRIPTION OF THE PREFERRED EMBODIMENTS

As used herein, the singular form of “a”, “an”, and “the” include the plural references unless the context clearly dictates otherwise. Thus, the articles “a” and “an” are used herein to refer to one or to more than one (i.e., to at least one) of the grammatical object of the article. By way of example, “an element” means one element or more than one element.

Directional phrases used herein, such as, for example and without limitation, top, bottom, left, right, lower, upper, front, back, and variations thereof, shall relate to the orientation of the elements shown in the accompanying drawing and are not limiting upon the claims unless otherwise expressly stated.

In the present application, including the claims, other than where otherwise indicated, all numbers expressing quantities, values or characteristics are to be understood as being modified in all instances by the term “about.” Thus, numbers may be read as if preceded by the word “about” even though the term “about” may not expressly appear with the number. Accordingly, unless indicated to the contrary, any numerical parameters set forth in the following description may vary depending on the desired properties one seeks to obtain in the compositions and methods according to the present disclosure. At the very least, and not as an attempt to limit the application of the doctrine of equivalents to the scope of the claims, each numerical parameter described in the present description should at least be construed in light of the number of reported significant digits and by applying ordinary rounding techniques.

Further, any numerical range recited herein is intended to include all sub-ranges subsumed therein. For example, a range of “1 to 10” is intended to include any and all sub-ranges between (and including) the recited minimum value of 1 and the recited maximum value of 10, that is, having a minimum value equal to or greater than 1 and a maximum value of equal to or less than 10.

The improved fuel is suitable for use in light water reactors and heavy water reactors. Light water reactors (LWR) are reactors that use ordinary water as the coolant, including boiling water reactors (BWRs) and pressurized water reactors (PWRs), the most common types used in the United States. A heavy water reactor (HWR) uses heavy water, i.e., deuterium oxide (D₂O) as its coolant and/or moderator. The heavy water coolant is kept under pressure, allowing it to be heated to higher temperatures without boiling, much as in a pressurized water reactor.

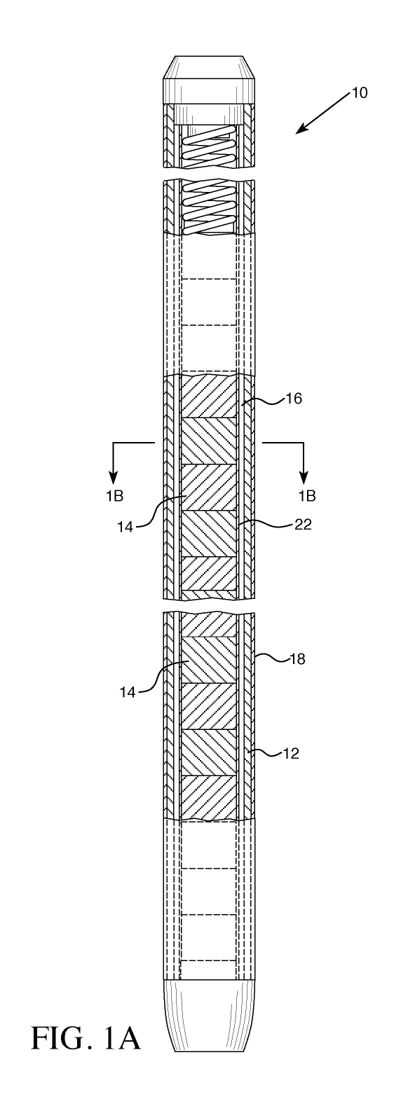

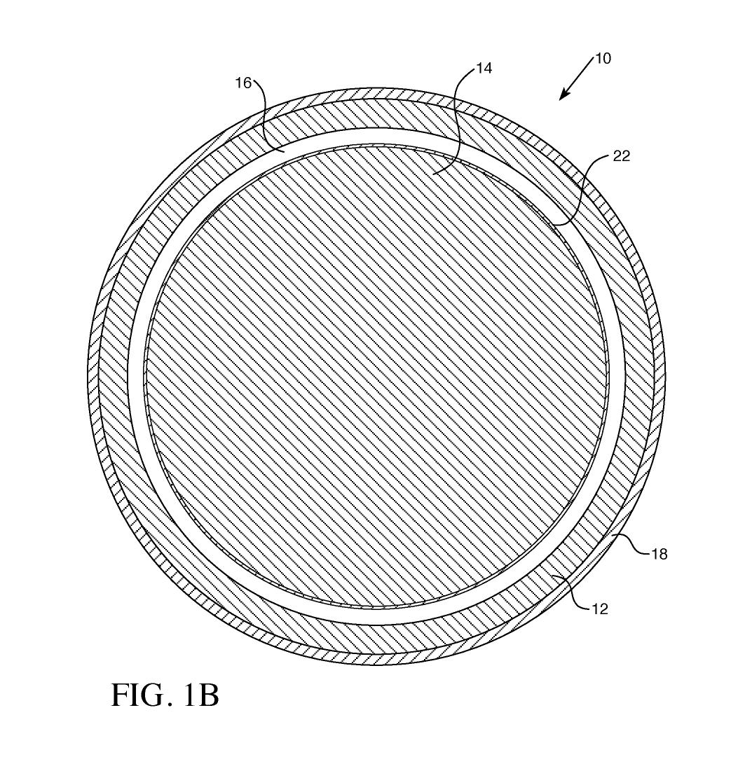

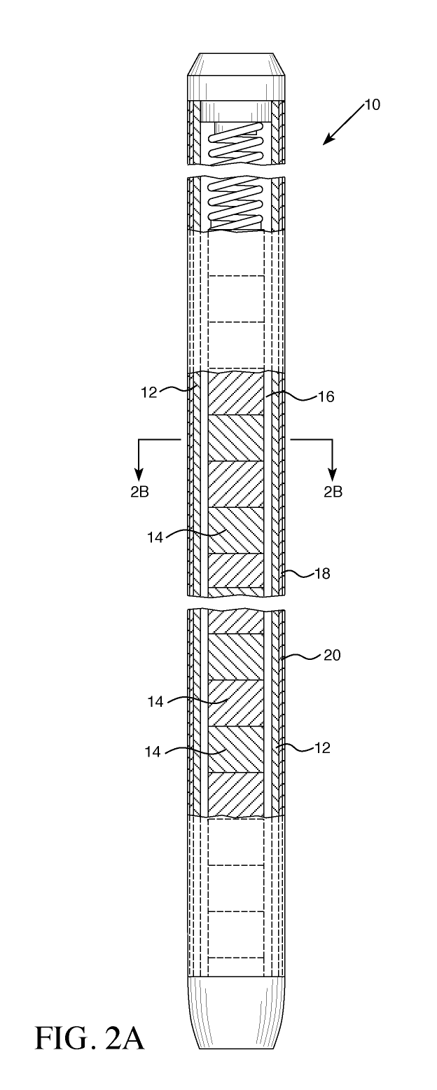

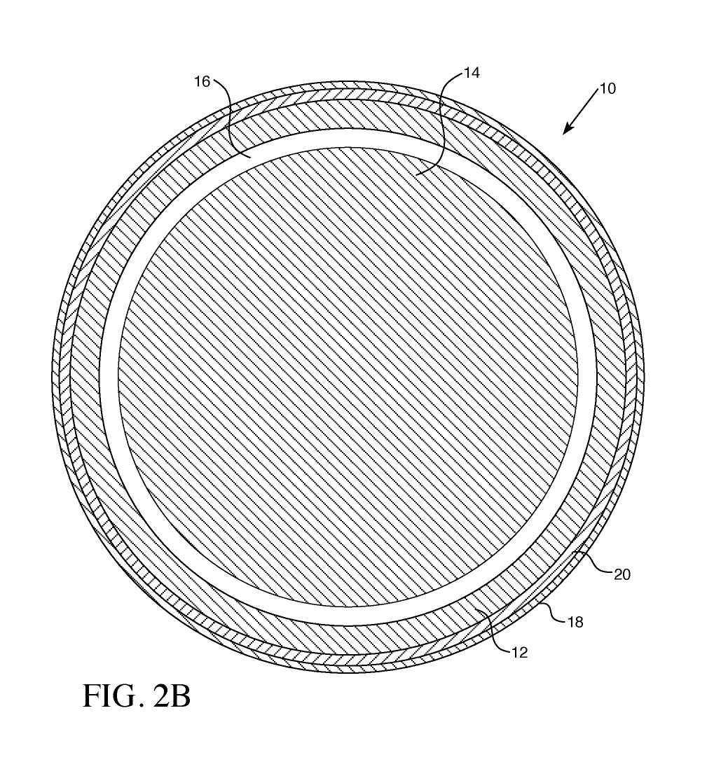

Referring to the accompanying Figures, an improved accident tolerant fuel rod 10 combines the strengths of each of the coated zirconium cladding 12, U₃Si₂ or UN fuel pellets 14, and a boron-containing material, such as UB₂ or a ZrB₂ as an integral fuel burnable absorber. A gap 16 separates the interior of the cladding 12 from the fuel pellets 14. Cladding 12 may, in various aspects, comprise zirconium or a zirconium alloy. The integral fuel burnable absorber may form a coating 22 on the fuel pellet 14 as shown in FIG. 1B, or may be intermixed with the fissile material in the pellet 14, as shown in FIG. 2B.

U₃Si₂ is particularly useful for use with coated zirconium alloy cladding because the initial pellet to fuel gap 16 can be small, due the ability of the coated zirconium cladding 12 to expand as the pellet 14 grows as the fuel burn-up increases during life, and the fact that the coated cladding 12 will creep down onto the fuel during the initial fuel use period. In the several reactions in the process for making U₃Si₂, constituents other than U₃Si₂ may form. The finished pellet 14 may therefore include U and Si containing constituents other than U₃Si₂ between 0% and 100%. The U₃Si₂ fuel in various aspects has a density between 80% and 99% of theoretical density. U₃Si₂ has a density of 12.2 gm/cm³. The U₃Si₂ fuel pellet may have a density between 9.76 gm/cm³ and 12.08 gm/cm³.

An alternative fuel may be UN, wherein the nitrogen content may be one or a combination of natural nitrogen and nitrogen enriched in the isotope of ¹⁵N. The UN fuel has a density between 80% and 99% of theoretical density. UN has an even higher density than U₃Si₂. The finished pellet 14 may include U and N containing constituents other than UN between 0% and 100%.

In various aspects, the zirconium alloy of cladding 12 may be coated ZIRLO™, made in accordance with the procedures disclosed in U.S. Pat. No. 4,649,023, incorporated in relevant part herein by reference. ZIRLO™ is an alloy comprising, by weight percent, 0.5-2.0 niobium, 0.7-1.5 tin, 0.07-0.14 iron, and 0.03-0.14 of at least one of nickel and chromium, and at least 0.12 total of iron, nickel and chromium, and up to 220 ppm C, and the balance essentially zirconium. Preferably, the alloy contains 0.03-0.08 chromium, and 0.03-0.08 nickel. Those skilled in the art will appreciate that other zirconium alloys may be acceptable for use in a desired application. In certain aspects, the Zr alloy cladding may be made of AXIOM™, a Zr based alloy generally comprised of 0.2 to 1.5 weight percent niobium, 0.01 to 0.6 weight percent iron, 0.0 to 0.8 weight percent tin, 0.0 to 0.5 weight percent chromium, 0.0 to 0.3 weight percent copper, 0.0 to 0.3 weight percent vanadium, 0.0 to 0.1 weight percent nickel, and a balance at least 97 weight percent zirconium, including impurities. In certain aspects, the Zr alloy may comprise 0.4 to 1.5 weight percent niobium, 0.4 to 0.8 weight percent tin, 0.05 to 0.3 weight percent iron, 0.0 to 0.5 weight percent chromium, and the balance at least 97 weight percent zirconium including impurities. See for example, U.S. Pat. Nos. 9,284,629 and 9,725,791, incorporated herein by reference.

The integral fuel burnable absorber may be UB₂ or ZrB₂. UB₂ has a high density (12.7 gm/cm³) and high melting point (2430° C.) but cannot be used for a fuel due to its water reactivity. Boron naturally occurs as stable isotopes B10 and B11, with B11 making up about 80% and B10 making up about 20% of natural boron. The B10 isotope cannot be used in a fuel in large amounts because the B10 isotope has a very large neutron cross-section that would make it impossible to start a reactor if there were a large quantity of UB₂ in the core. Therefore, if UB₂ were to be used as a fuel, most of the B10 would have to be removed so that only about 100 to 1000 parts per million (ppm) remained. This would increase the cost of the fuel and make it uneconomical in relation to UO₂ or U₃Si₂. Boron, when used as an integral fuel burnable absorber, may be sprayed in very small quantities on the outside of fuel pellets in the form of UB₂ or ZrB₂ to form coating 22. ZrB₂, like UB₂, is known to interact with the oxygen (for example, in UO₂ in those instances when UO₂ is used as the fissile material) to form BOx (where x is a number indicative of a different phase) during the sintering process, driving off the boron contained within the pellet 14. In the process for making UB₂, other constituents may be formed. When the integral burnable absorber is UB₂, there may be UBx components of between 0% and 100%, where x is a whole number or fraction thereof from 0 to 12 or more, such as UB_{1.5}, UB₄, UB₆ or UB₁₂, or some other phase.

In the fuel system described herein, the boron-containing components may be added to the fissile material powder forming the fuel pellet 14, thereby providing a tremendous cost saving compared to spraying boron-compounds as a very thin, uniform coating on the outer surface of all of the pellets. The boron-containing integral burnable absorber described herein does not interact with U₃Si₂ when U₃Si₂ is used as the fissile material. Therefore, it can be added directly to the U₃Si₂ powder before pelleting and can be sintered at a very large cost savings and an increase in quality due to the uniformity achieved by this approach compared to the spray methods heretofore used. Since more UB₂ and ZrB₂ can be added to the pellet, enrichment of the B10 isotope content that had been necessary in order to minimize the thickness of the coating is not required, resulting in a further significant cost saving. The boron-containing integral burnable absorber used in the fuel system described herein may have a B10 isotope content at 1% to 90% of the boron. Since UB₂ also has a very high density, the higher addition rates does not significantly affect the total uranium density of the U₃Si₂ pellet.

Referring to FIGS. 2A and 2B, the fuel rod 10 utilizes zirconium alloy cladding 12 with a coating 18, but more preferably a coating 18 with an interlayer 20. The interlayer may have a thickness of 1 to 20 microns. The coating may be selected from the group consisting of Cr and Cr alloys. The Cr alloy may, for example, be FeCrAl or FeCrAlY.

The interlayer may be selected from the group consisting of a Mo, Ta, W, and Nb.

When the interlayer is Nb, for example, it provides very low leakage failures and resistance to very high temperatures (˜1700° C.) during beyond design basis accidents. The hard Cr or Cr alloy outer layer 18 provides a very low leakage failure rate which allows the use of the water sensitive U₃Si₂ and UB₂ or ZrB₂. U₃Si₂ provides the high density for excellent economics of operation and the high thermal conductivity and reasonable melting temperature required for good reactor operability.

In various aspects, the pellet 14 with or without coating 22 may be combined with the cladding 12 having both interlayer 20 and outer layer 18. In various aspects, the pellet 14 with or without coating 22 may be combined with the cladding 12 having the coating layer 18, without interlayer 20.

In certain embodiments, the coated zirconium alloy cladded U₃Si₂ fuel having a boron-containing integral fuel burnable absorber described herein takes advantage of the strong points of each of the components. The U₃Si₂ fuel has a low operating temperature, high thermal conductivity, and high density. The Zr coated cladding 12 has a high decomposition temperature, which protects the U₃Si₂ fuel. The melting point and boron content of the UB₂ or ZrB₂ boron-containing integral burnable absorber produces a fuel which optimizes performance during normal operation as well as providing a high level of accident tolerance compared to the current UO₂ fueled/Zr clad nuclear fuel component combination.

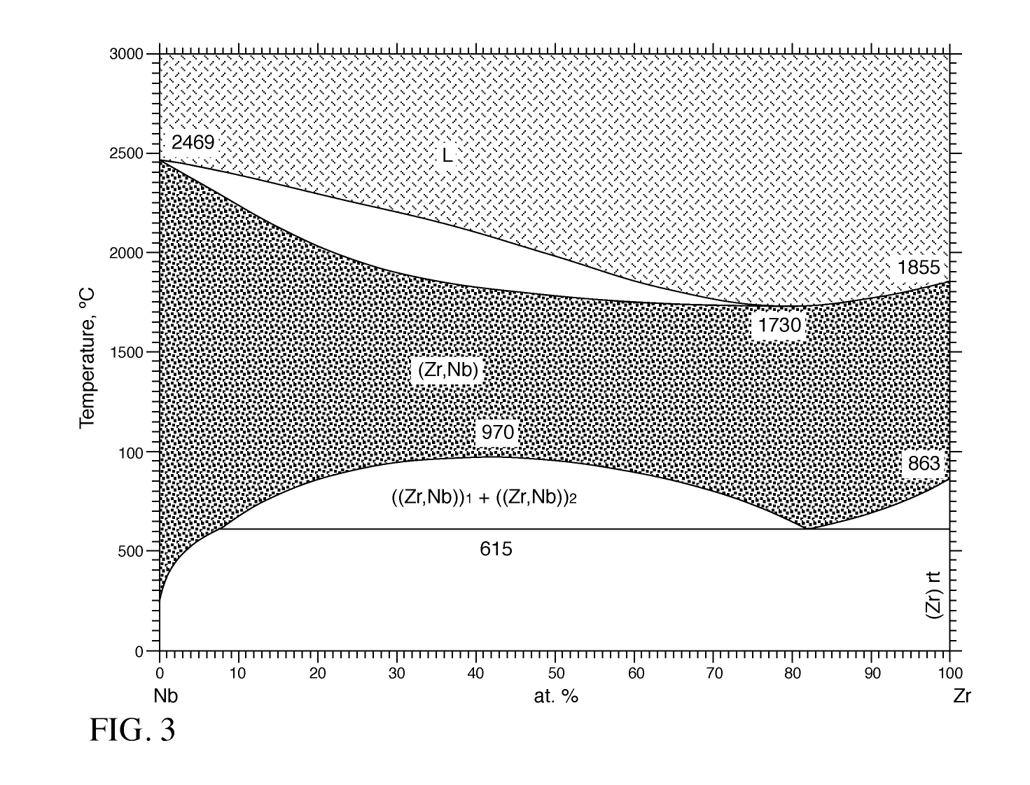

This combination of features in the improved fuel rod 10 described herein utilizes the best features of U₃Si₂, coated Zr and UB₂ or ZrB₂ to overcome the inherent weaknesses of each. For example, it is not feasible to use U₃Si₂ fuels and UB₂ integral fuel burnable absorbers in current metal claddings because of the relatively high leak rate of the cladding, which gives rise to unacceptable reactions with the coolant, resulting in a fuel rod failure. The use of the Cr or Cr alloy coated cladding 12 with a Mo, Ta, W, or Nb interlayer 20 provides a very hard cladding with a very high eutectic melting point that dramatically decreases the potential for fuel leakers while increasing the temperature capability of the fuel by more than 300° C. above the current Cr only coating. Referring to FIG. 3, a phase diagram illustrates the eutectic for the Zr, Nb combination. The phase diagram plots relative concentrations of Nb and Zr along the horizontal axis, and temperature along the vertical axis. The eutectic point is the point at which the liquid phase (L) borders directly on the solid phase (composed of both Nb and Zr), representing the minimum melting temperature of any possible alloy of Nb and Zr.

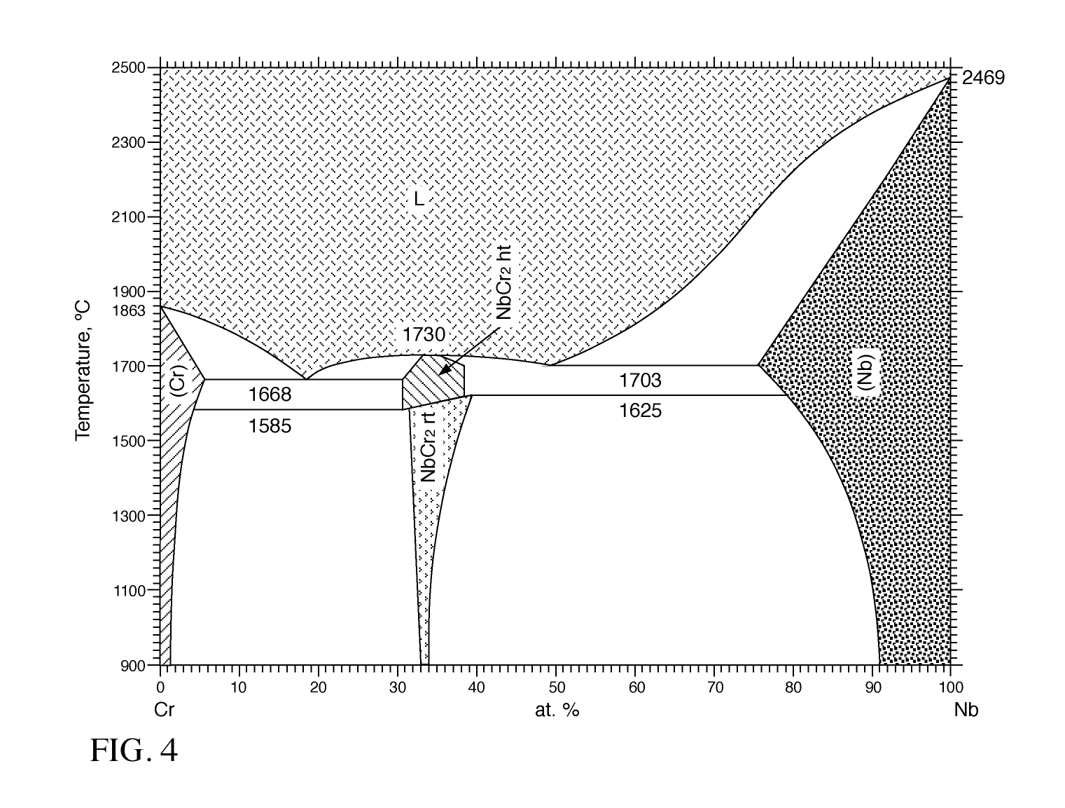

FIG. 4 illustrates the phase diagram showing the eutectic for the Nb, Cr combination. The phase diagram plots relative concentrations of Nb and Cr along the horizontal axis, and temperature along the vertical axis. The eutectic point is the point at which the liquid phase (L) borders directly on the solid phase (composed of both Nb and Cr), representing the minimum melting temperature of any possible alloy of Nb and Cr.

The use of a boron-containing integral fuel burnable absorber, such as UB₂ or ZrB₂, provides a means of controlling the high initial nuclear reactivity of the U₃Si₂ due to its high density by providing an economical means of adding boron to U₃Si₂, and in various aspects, adding enough boron to the U₃Si₂ powder before pelleting. Further, the U₃Si₂ does not react with UB₂ or ZrB₂, thus, in various alternative aspects, allowing particles of boron-containing integral fuel burnable absorber to be added to the U₃Si₂ powder before sintering.

The tubes, rods, slugs and pellets described herein may be machined or formed by any method known to those skilled in the art. Because of the close tolerances for size, configuration, and other properties identified herein and those known to be relevant in the nuclear industry, precision manufacturing methods should be used.

The fuel pellets 14 may be formed by known methods of manufacturing pellets in other commercial contexts. For example, the U₃Si₂ fuel in powder or particulate form, may be formed into a pellet by first homogenizing the particles to ensure relative uniformity in terms of particle size distribution and surface area. The integral fuel burnable absorber, UB₂ or ZrB₂ for example, also in powder or particulate form, and in certain aspects, other additives, such as lubricants and pore-forming agents, would be added. The integral fuel burnable absorber content in the U₃Si₂ pellet may be between 100 ppm and 10000 ppm, and in various aspects, may be about 1000 ppm.

The U₃Si₂ and boron-containing integral fuel burnable absorber particles may be formed into pellets by compressing the mixture of particles in suitable commercially available mechanical or hydraulic presses to achieve the desired “green” density and strength.

A basic press may incorporate a die platen with single action capability while the most complex styles have multiple moving platens to form “multi-level” parts. Presses are available in a wide range of tonnage capability. The tonnage required to press powder into the desired compact pellet shape is determined by multiplying the projected surface area of the part by a load factor determined by the compressibility characteristics of the powder.

To begin the process, the mixture of particles is filled into a die. The rate of die filling is based largely on the flowability of the particles.

Once the die is filled, a punch moves towards the particles. The punch applies pressure to the particles, compacting them to the geometry of the die. In certain pelleting processes, the particles may be fed into a die and pressed biaxially into cylindrical pellets using a load of several hundred MPa.

Following compression, the pellets 14 are sintered by heating in a furnace at temperatures varying with the material being sintered under a controlled atmosphere, usually comprised of argon. Sintering is a thermal process that consolidates the green pellets by converting the mechanical bonds of the particles formed during compression into stronger bonds and greatly strengthened pellets. The compressed and sintered pellets are then cooled and machined to the desired dimensions. Exemplary pellets may be about one centimeter, or slightly less, in diameter, and one centimeter, or slightly more, in length.

In certain aspects, the integral fuel burnable absorber is not intermixed with the fissile material in the pellet 14, but applied as a coating 22 to the outer surface of the pellet 14. The application of the UB₂ or ZrB₂ to the surface of the pellet 14 may be by any known method, such as a spray method or another method of coating.

The fuel pellets 14, either coated with or intermixed with, the integral fuel burnable absorber are stacked in a Zr or Zr alloy cladding 12. The cladding 12 will have been coated with a Cr coating 18, which may be applied using a thermal deposition process, such as a cold spray process. Where there are two layers, the intermediate Nb interlayer 20 will be deposited on the Zr cladding 12 first and may be ground and polished before deposition of the outer Cr layer 18, which can be ground and polished thereafter. The interlayer 20 may be deposited by using a physical vapor deposition method, such as cathodic arc physical vapor deposition, or a hot spray process, such as a plasma arc spray method.

Cathodic arc vapor deposition involves a source material and a substrate to be coated placed in an evacuated deposition chamber. The chamber contains only a relatively small amount of gas. The negative lead of a direct current (DC) power supply is attached to the source material (the “cathode”) and the positive lead is attached to an anode. In many cases, the positive lead is attached to the deposition chamber, thereby making the chamber the anode. The electric arc is used to vaporize material from the cathode target. The vaporized material then condenses on the substrate, forming the desired layer.

A cold spray method may proceed by delivering a carrier gas to a heater where the carrier gas is heated to a temperature sufficient to maintain the gas at a desired temperature, for example, from 100° C. to 500° C., after expansion of the gas as it passes through a nozzle. In various aspects, the carrier gas may be pre-heated to a temperature between 200° C. and 1200° C., with a pressure, for example, of 5.0 MPa. In certain aspects, the carrier gas may be pre-heated to a temperature between 200° C. and 1000° C., or in certain aspects, 300° C. and 900° C. and in other aspects, between 500° C. and 800° C. The temperature will depend on the Joule-Thomson cooling coefficient of the particular gas used as the carrier. Whether or not a gas cools upon expansion or compression when subjected to pressure changes depends on the value of its Joule-Thomson coefficient. For positive Joule-Thomson coefficients, the carrier gas cools and must be preheated to prevent excessive cooling which can affect the performance of the cold spray process. Those skilled in the art can determine the degree of heating using well known calculations to prevent excessive cooling. See, for example, for N₂ as a carrier gas, if the inlet temperature is 130° C., the Joule-Thomson coefficient is 0.1° C./bar. For the gas to impact the tube at 130° C. if its initial pressure is 10 bar (˜146.9 psia) and the final pressure is 1 bar (˜14.69 psia), then the gas needs to be preheated to about 9 bar*0.1° C./bar or about 0.9 C to about 130.9° C.

For example, the temperature for helium gas as the carrier is preferably 450° C. at a pressure of 3.0 to 4.0 MPa, and the temperature for nitrogen as the carrier may be 1100° C. at a pressure of 5.0 MPa, but may also be 600° C.-800° C. at a pressure of 3.0 to 4.0 MPa. Those skilled in the art will recognize that the temperature and pressure variables may change depending on the type of the equipment used and that equipment can be modified to adjust the temperature, pressure and volume parameters.

Suitable carrier gases are those that are inert or are not reactive, and those that particularly will not react with the Cr particles or the Nb interlayer or Zr substrate to be coated. Exemplary carrier gases include nitrogen (N₂), hydrogen (H₂), argon (Ar), carbon dioxide (CO₂), and helium (He).

There is considerable flexibility in regard to the selected carrier gases. Mixtures of gases may be used. Selection is driven by both physics and economics. For example, lower molecular weight gases provide higher velocities, but the highest velocities should be avoided as they could lead to a rebound of particles and therefore diminish the number of deposited particles.

In an exemplary cold spray process, a high pressure gas enters through a conduit to a heater, where heating occurs quickly; substantially instantaneously. When heated to the desired temperature, the gas is directed to a gun-like instrument. Particles of the desired coating material, in this case, Cr, are held in a hopper, and are released and directed to the gun where they are forced through a nozzle towards the rod or tube substrate by a pressurized gas jet. The sprayed Cr particles are deposited onto rod or tube surface to form a coating comprised of the particles

Following the deposition of the coating 18, the method may further include annealing the coating. Annealing modifies mechanical properties and microstructure of the coated tube. Annealing involves heating the coating in the temperature range of 200° C. to 800° C. but preferably between 350° C. to 650° C.

The coated substrate may also be ground, buffed, polished, or otherwise further processed following the coating or annealing steps by any of a variety of known means to achieve a smoother surface finish.

The present invention has been described in accordance with several examples, which are intended to be illustrative in all aspects rather than restrictive. Thus, the present invention is capable of many variations in detailed implementation, which may be derived from the description contained herein by a person of ordinary skill in the art.

All patents, patent applications, publications, or other disclosure material mentioned herein, are hereby incorporated by reference in their entirety as if each individual reference was expressly incorporated by reference respectively. All references, and any material, or portion thereof, that are said to be incorporated by reference herein are incorporated herein only to the extent that the incorporated material does not conflict with existing definitions, statements, or other disclosure material set forth in this disclosure. As such, and to the extent necessary, the disclosure as set forth herein supersedes any conflicting material incorporated herein by reference and the disclosure expressly set forth in the present application controls.

The present invention has been described with reference to various exemplary and illustrative embodiments. The embodiments described herein are understood as providing illustrative features of varying detail of various embodiments of the disclosed invention; and therefore, unless otherwise specified, it is to be understood that, to the extent possible, one or more features, elements, components, constituents, ingredients, structures, modules, and/or aspects of the disclosed embodiments may be combined, separated, interchanged, and/or rearranged with or relative to one or more other features, elements, components, constituents, ingredients, structures, modules, and/or aspects of the disclosed embodiments without departing from the scope of the disclosed invention. Accordingly, it will be recognized by persons having ordinary skill in the art that various substitutions, modifications or combinations of any of the exemplary embodiments may be made without departing from the scope of the invention. In addition, persons skilled in the art will recognize, or be able to ascertain using no more than routine experimentation, many equivalents to the various embodiments of the invention described herein upon review of this specification. Thus, the invention is not limited by the description of the various embodiments, but rather by the claims.

What is claimed is:

1. An accident tolerant fuel rod for light and heavy water reactors comprising:
a nuclear fuel selected from the group consisting of U₃Si₂ and UN, in pellet form;
a boron-containing integral fuel burnable absorber; and
a zirconium-containing cladding material for housing the nuclear fuel and the integral fuel burnable absorber, the cladding material having a coating applied thereto.

2. The fuel rod recited in claim 1 further comprising an interlayer disposed between the cladding material and the coating.

3. The fuel rod recited in claim 2 wherein the interlayer has a thickness of 1 to 20 microns.

4. The fuel rod recited in claim 2 wherein the interlayer is selected from the group consisting of a Mo, Ta, W, and Nb.

5. The fuel rod recited in claim 2 wherein the interlayer is applied to the cladding material by a hot spray process.

6. The fuel rod recited in claim 5 wherein the hot spray process is a plasma arc process.

7. The fuel rod recited in claim 1 wherein the coating is selected from the group consisting of chromium and a chromium alloy.

8. The fuel rod recited in claim 7 wherein the chromium alloy is selected from the group consisting of FeCrAl and FeCrAlY.

9. The fuel rod recited in claim 1 wherein the coating has a thickness of 5 to 50 microns.

10. The fuel rod recited in claim 1 wherein the coating is applied to the cladding material by a cold spray process.

11. The fuel rod recited in claim 1 wherein the integral fuel burnable absorber is selected from the group consisting of UB₂ and ZrB₂.

12. The fuel rod recited in claim 1 wherein the integral fuel burnable absorber is intermixed with the nuclear fuel in the pellet.

13. The fuel rod recited in claim 12 wherein the integral fuel burnable absorber content in the pellet is between 100 ppm and 10000 ppm.

14. The fuel rod recited in claim 1 wherein the integral fuel burnable absorber is coated on the surface of the fuel pellet.

15. The fuel rod recited in claim 1 wherein the B10 isotope content of the integral burnable absorber is between 1% and 90%.

16. The fuel rod recited in claim 1 wherein the integral burnable absorber is UB₂ having UBx components of between 0% and 100%, where x is a whole number or fraction thereof from 0 to 12.

17. The fuel rod recited in claim 1 wherein the nuclear fuel comprises U₃Si₂ having a density between 80% and 99% of theoretical density.

18. The fuel rod recited in claim 17 wherein the pellet further comprises U and Si containing constituents other than U₃Si₂ between 0% and 100%.

19. The fuel rod recited in claim 1 wherein the nuclear fuel comprises UN, the nitrogen being selected from natural nitrogen and nitrogen enriched in the isotope of ¹⁵N, and the UN having a density between 80% and 99% of theoretical density.

20. The fuel rod recited in claim 19 wherein the pellet further comprises U and N containing constituents other than UN between 0% and 100%.
